(19) United States
(12) Patent Application Publication
(10) Pub. No.: US 2009/0006646 A1
(43) Pub. Date: Jan. 1, 2009

(54) System and Method of Auto Populating Forms on Websites With Data From Central Database

(75) Inventor: Keith B. Duarte, Newport Coast, CA (US)

Correspondence Address: FOUNTAIN LAW GROUP, INC., 18201 VON KARMAN AVENUE, SUITE 960, IRVINE, CA, 92612, US

(73) Assignee: DATA FRENZY, LLC, Newport Beach, CA (US)

(21) Appl. No.: 11/768,879

(22) Filed: Jun. 26, 2007

(51) Int. Cl. G06F 15/16

(52) U.S. Cl. 709/236

(57) ABSTRACT

A system and method for automatically populating a form on one or more webpages with data originating from a central database. According to one embodiment, a user communication device receives the data from a first server via a network, accesses the form on the one or more webpages via the network, automatically populates one or more fields of the form with some or all of the data, and sends the populated form to a second server via the network. According to another embodiment, a framed browser containing the data is generated by the user communication device, which automatically populates the form with some or all of the data when the user visits the corresponding website. According to yet another embodiment, an auto populate program (e.g., a toolbar or widget program) is executed by the user communication device for automatically populating the form with some or all of the data when the user visits the corresponding website. The framed browser or program may report back to the first server with information related to the submission of the populated form.

### FIELD OF THE INVENTION

This invention relates generally to communication of information over a communications network, and in particular, to a system and method of auto populating forms on websites with information that originates from a central database.

### BACKGROUND OF THE INVENTION

Users on the Internet often have to fill out various forms on visited websites. Often, these forms require the same information from the user. For example, on-line shopping website typically include a form to receive credit card and shipping information from a user. Such form typically includes fields like user first name, user middle initial, user last name, credit card type, credit card number, credit card expiration date, credit card security code, billing address, shipping address, etc.

Generally, each time a user visits such a website and purchases one or more items, the user has to complete such form. If the user visits and purchases items from different websites, the user would have to enter the same information multiple times. This could be very time consuming, tedious, and generally undesirable for a user. One solution that addresses this problem has been implemented in the field of posting resumes on resume posting websites. This solution is explained with reference to the following.

FIG. 1 illustrates a block diagram of an exemplary communications system 100 for providing resume information to servers operated by job posting websites. In this example, the communication system 100 allows a user to posts his/her resume on multiple job posting website while requiring the user to only enter the resume data once. The communications system 100 includes a network 102, such as the Internet, a resume processing server 104 coupled to the network 102, a user communication device 106 coupled to the network 102, and a plurality of resume posts servers 108 and 110 coupled to the network 102.

A user, using the communication device 106, accesses, for example, a website provided by the resume processing server 104. The website includes a form for receiving resume data from the user. In response to the user entering the resume data and clicking a submit button, the user communication device 106 sends the resume data to the resume processing server 104 via the network 102. The resume processing server 104, in turn, stores the user's resume data in a local database.

The website provided by the resume processing server 104 may also include an input object to receive, for example, information identifying selected resume posting entities to which the user would like his/her resume posted. In response to the user entering the selection, the user communication device 106 sends the resume posting entity information to the resume processing server 104 via the network 102. In this example, the user has selected the entities operating resume posts servers 108 and 110. The resume processing server 104 then accesses the user's resume data from the local database, and sends it for posting to the resume posts servers 108 and 110 via the network 102.

Thus, in this example, the user only had to enter his/her resume once, by accessing the website provided by the resume processing server 104. However, there are some resume posting entities that do not accept resume data coming from the resume processing server. Instead, these entities prefer that the user accesses their websites to input the resume data directly into the provided forms. In such situation, the user may have to enter his/her resume data each time the user accesses one of these websites. As discussed above, this could be very time consuming, tedious, and generally undesirable for a user.

### BRIEF DESCRIPTION OF THE DRAWINGS

FIG. 1 illustrates a block diagram of an exemplary communications system for providing resume information to servers operated by job posting websites;

FIG. 2 illustrates a block diagram of an exemplary communications system in accordance with an embodiment of the invention;

FIG. 3A illustrates a flow diagram of an exemplary method of providing information to a user communication device for the purpose of auto populating one or more website forms with information in accordance with another embodiment of the invention;

FIG. 3B illustrates a flow diagram of an exemplary method of auto populating a form on a website with information in accordance with another embodiment of the invention;

FIG. 3C illustrates a screen shot of an exemplary framed browser for performing an auto populating function in accordance with another embodiment of the invention;

FIG. 4A illustrates a flow diagram of another exemplary method of providing information to a user communication device for the purpose of auto populating one or more website forms with information in accordance with another embodiment of the invention;

FIG. 4B illustrates a flow diagram of another exemplary method of auto populating a form on a website with information in accordance with another embodiment of the invention;

FIG. 4C illustrates a screen shot of an exemplary toolbar for performing an auto populating function in accordance with another embodiment of the invention;

FIG. 4D illustrates a screen shot of the exemplary auto populate widget program for performing an auto populating function in accordance with another embodiment of the invention;

FIG. 5 illustrates a block diagram of another exemplary communications system in accordance with an embodiment of the invention;

FIG. 6A illustrates a flow diagram of an exemplary method of auto populating a form on a website with information in accordance with another embodiment of the invention;

FIG. 6B illustrates a block diagram of an exemplary user communication device in accordance with another embodiment of the invention;

FIG. 7A illustrates an exemplary table related to an exemplary website form in accordance with another embodiment of the invention;

FIG. 7B illustrates an exemplary table for mapping of field names used in website to a root name in accordance with another embodiment of the invention; and

FIG. 7C illustrates an exemplary table for mapping the root names to corresponding resume data in accordance with another embodiment of the invention.

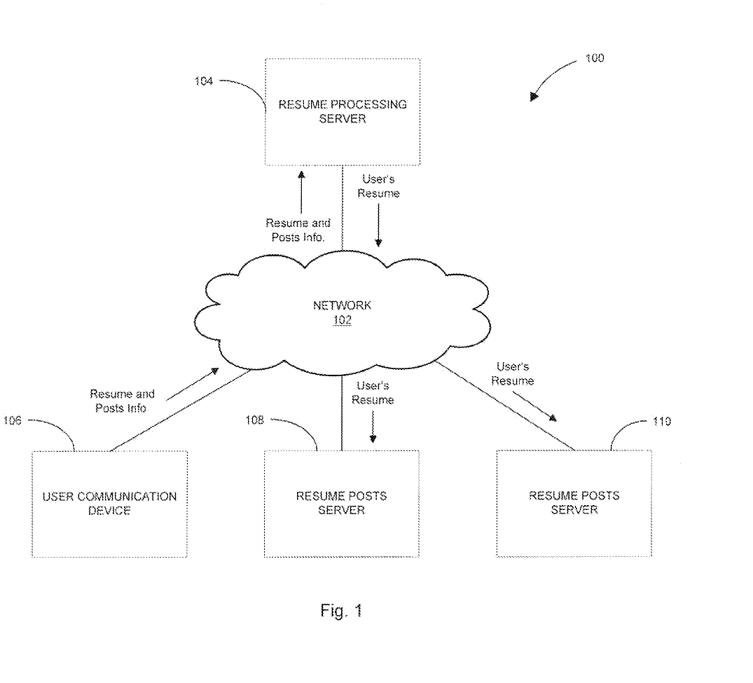

### DETAILED DESCRIPTION OF THE EXEMPLARY EMBODIMENTS

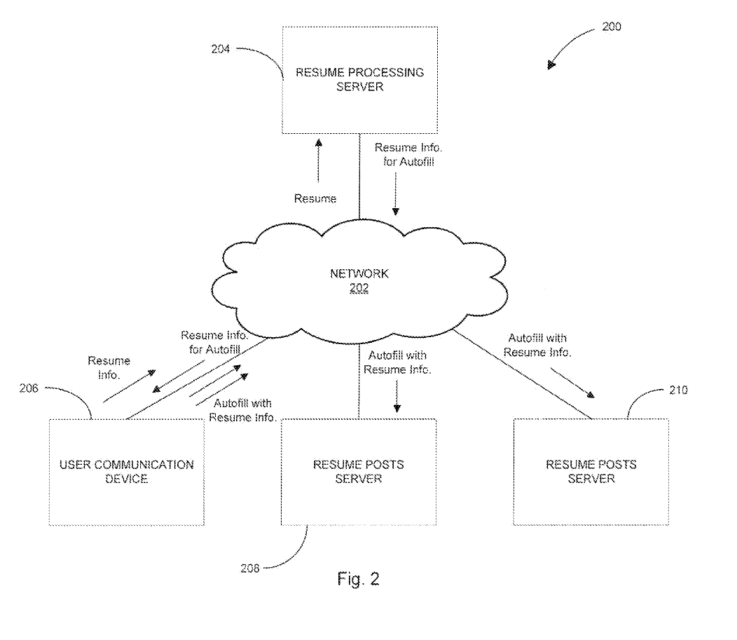

FIG. 2 illustrates a block diagram of an exemplary communications system 200 in accordance with an embodiment of the invention. The communications system 200 allows a user to auto populate a form on a website with information which originates from a central database. Thus, a user need only input the data once into the central database, and use the auto populate feature to complete forms on websites visited by the user. This significantly facilitates the form completion process for the user.

In this disclosure, the completion of a form at a resume posts website is used to exemplify the various embodiments of the invention. It shall be understood that the auto populate concept described herein shall be applicable to the completion of website forms for any type of data. Such types of data may include biographical information, credit card information, shipping information, financial information, dating profile information, and others.

More specifically, the communications system 200 comprises a network 202, a resume processing server 204 coupled to the network 202, a user communication device 206 coupled to the network 202, and one or more resume posts servers, such as servers 208 and 210. The network 202 may be any type of communications network, such as a wide area network (WAN) (e.g., the Internet), a local area network (LAN), a wireless and/or wired communications network, a cellular and/or landline telephone network, and others. The resume processing server 204 includes a database that stores resume data of a plurality of users, such as the resume of the user operating the user communication device 206 as exemplified herein.

The user communication device 206 may be any communication device for communication of data with any other elements coupled to the network 202, such as the resume processing server 204 and the resume posts servers 208 and 210 described herein. For example, the user communication device 206 may include a personal desktop computer, a laptop computer, a personal digital assistant (PDA), a cellular telephone device, and others. The resume posts server 208 and 210 each provide a website including one or more webpages (e.g., a hyper text markup language (HTML) document) including a form adapted to receive resume data for posting to allow prospective employers to view the information.

The process of auto populating forms on resume posts websites with the user resume data that originates from a database accessible by the resume processing server 204 will now be described. First, the user using the user communication device 206 sends his/her resume information to the resume processing server 204 via the network 202. In this regard, for example, the user using the user communication device 206 may access a website provided by the resume processing server 204 which may have a form to receive resume data. There may be other methods for which the resume processing server 204 may receive the resume data from the user, such as by email, for example. Once the resume processing server 204 receives the resume data, it stores it in a database, which could be a local or remote database.

As will be discussed in more detail with reference to a couple of exemplary embodiments, the user, using the user communication device 206, sends a request to activate the auto populate function to the resume processing server 204 via the network 202. As discussed in more detail below, the user may click on a link on a website provided by the resume processing server 204 or may download a program which sends the auto populate request to the resume processing server 204. In response to the request, the resume processing server 204 accesses the user's resume data from the database and sends it to the user communication device 206 via the network 202. In one example, the resume processing server 204 causes the user communication device 206 to produce a framed browser having the user resume data embedded therein. In another example, an auto populate program (e.g., configured as a toolbar or widget) running on the user communication device 206 captures the resume data sent by the resume processing server 204.

Once the user communication device 206 receives the user resume data, the user may use the user communication device 206 to access one or more webpages provided by any of the resume posts servers 208 and 210 via the network 202. The one or more webpages includes a form to receive the user's resume data. The user then using the user communication device 206 activates the auto populate function provided by, for example, the framed browser or the auto populate program to populate the form on the website provided by the resume posts server. The user may optionally add and/or edit the populated form and then submit the populated form to the resume posts server. Thus, in accordance with the communications system 200, the user only had to enter the resume data once (e.g., via the website provided by the resume processing server 204), and uses the auto populate feature to populate forms on any site visited by the user. This significantly simplifies the form completion process for the user.

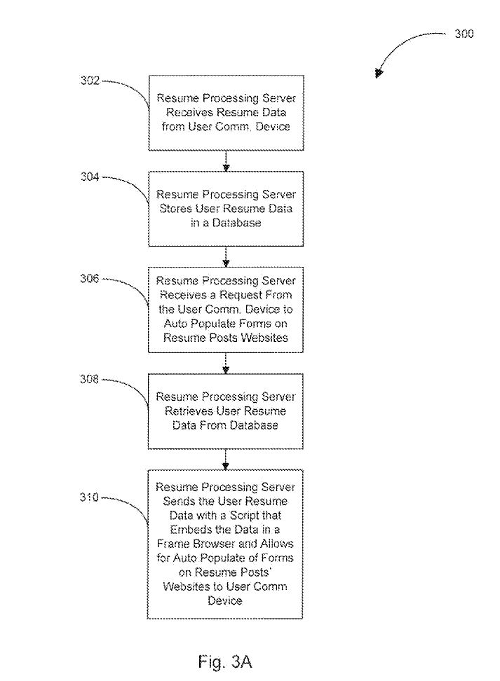

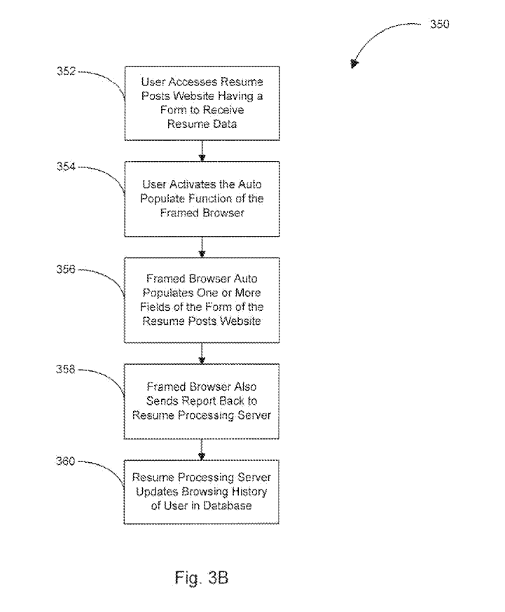

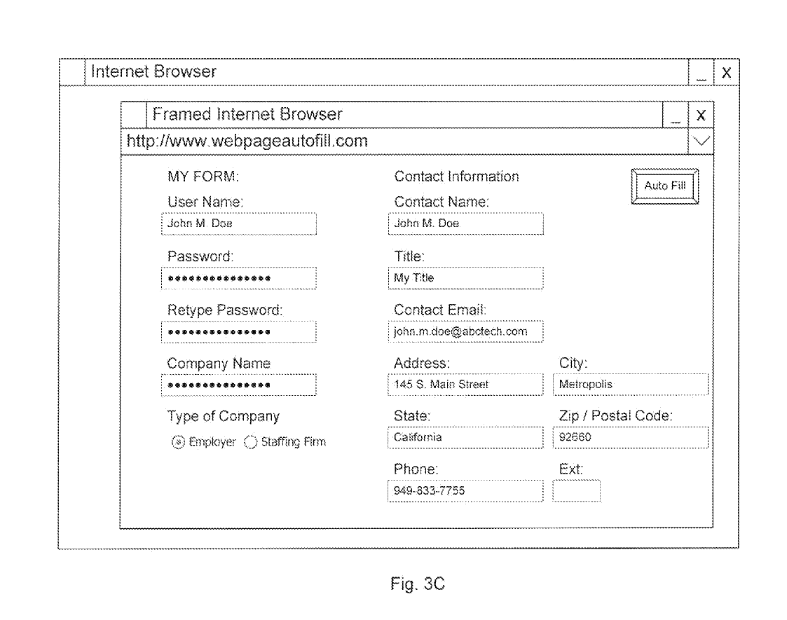

FIG. 3A illustrates a flow diagram of an exemplary method 300 of providing information to a user communication device for the purpose of auto populating one or more website forms with information in accordance with another embodiment of the invention. In this example, the operations of the method 300 are implemented by the resume processing server 204. According to the method 300, the resume processing server 204 receives the resume data from the user communication device 206 via the network 202 (block 302). As discussed above, the resume processing server 204 may receive the user's resume data in a number of different manners. The resume processing server 204 then stores the resume data in a database, such as a local database or a remote database (block 304).

The resume processing server 204 then receives a request from the user communication device 206 to auto populate one or more forms respectively on one or more job posts websites (block 306). In response to the request, the resume processing server 204 then retrieves the user resume data from the local or remote database (block 308). Then, the resume processing server 204 sends the user resume data including a script (e.g., a Java Script) to cause the user communication device 206 to generate a framed browser including the user resume data (block 310).

FIG. 3B illustrates a flow diagram of an exemplary method 350 of auto populating a form on a website in accordance with another embodiment of the invention. The method 350 is mainly implemented by the user communication device 206 using the auto populate framed browser. According to the method 350, the user accesses one or more webpages provided by any of the job posts servers 208 and 210 (block 352). The one or more webpage includes a form to receive the user's resume data. The user then activates the auto populate framed browser running on the user communication device 206 (block 354). Once the auto populate framed browser is activated, the framed browser causes one or more fields of the form to be populated with at least a portion of the resume data (block 356). If the form is spread over two or more webpages, the user may have to activate the auto populate framed browser for each of the webpages. Alternatively, the framed browser may auto-complete sequential pages on behalf of the user, leaving the user at the final completion page. For example, in some websites that require the user to complete several pages, if there is enough data in the database to complete all sequential pages, the framed browser sets completes the form portion on each page and leave the user on the final “Request Complete” page. The user may then have to activate a submit button on the appropriate webpage to cause the user communication device 206 to send the resume data to the job posts server 208 or 210 via the network 202. Alternatively, the framed browser may also be able to automatically submit the resume data to the job posts server. Blocks 354 and 356 may be repeated to complete a form for each of the visited job posts website.

After populating the form on the one or more webpages, the auto populate framed browser may cause the user communication device 206 to send a report regarding the auto populate operation to the resume processing server 204 via the network 202 (block 358). For example, the report may indicate information related to the website pertaining to the submitted form (e.g., a URL, the name of the job posts entity, etc.), the time and date of the auto populating operation, and any other pertinent information. Additionally, the report may further indicate one or more fields that were not completed, as well as one or more fields including its corresponding content that the user edited prior to submission. In response to receiving the report, the resume processing server 204 updates a history log pertaining to the user with the information contained in the report (block 360). The history log may be stored in the local or remote database. Also, the resume processing server 204 may update the resume information based on the information on the form edited by the user.

FIG. 3C illustrates a screen shot of an exemplary framed browser for performing an auto populating function in accordance with another embodiment of the invention. As the screen shot illustrates, the framed internet browser may be a separate window from the window of the internet browser. The framed internet browser includes an input to receive URL of website in which a user desires to visit. In this example, the user has access the webpage indicated by URL “http://www.webpageautofill.com.” The webpage includes a form entitled “MY FORM” which has several fields including “User Name:”, “Password:”, “Retype Password:”, “Company Name”, “Type of Company”, and so on as indicated. When the user initially accesses the webpage, the fields of the form are typically blank or may have some default information therein. The framed internet browser may be adapted to provide some visual indicator (e.g., highlight, change color, etc.) to the fields of the webpage form in which it is capable of auto populating with corresponding resume information. This would remind the user of the framed browser's ability to auto populate the emphasized fields of the webpage form. The framed internet browser includes an auto fill button. When the user activates the auto fill button, the framed buffer populates the fields of the form with the embedded data as shown. If the user needs to fill another form on another webpage, the user accesses the webpage by inputting its URL on the framed buffer, and then activate the auto fill button to populate the various fields of the form.

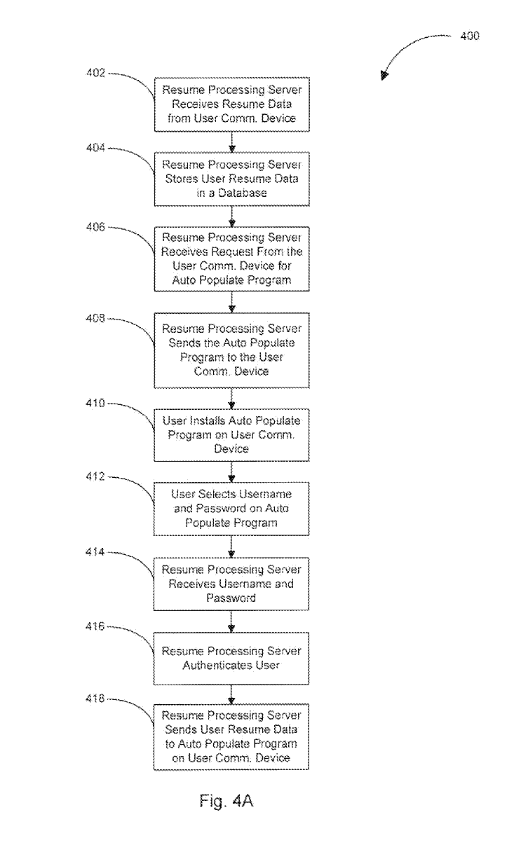

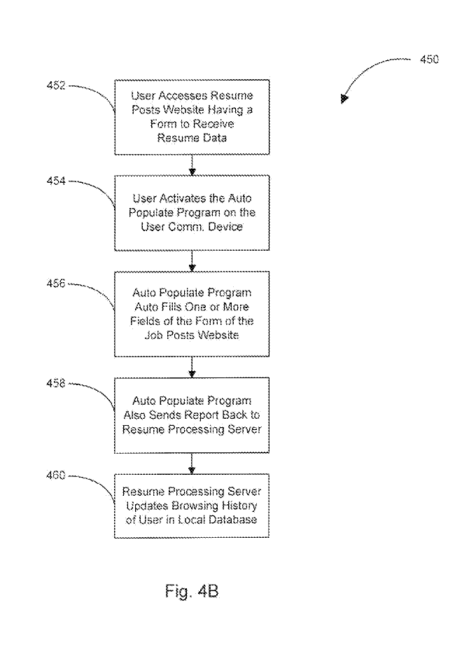

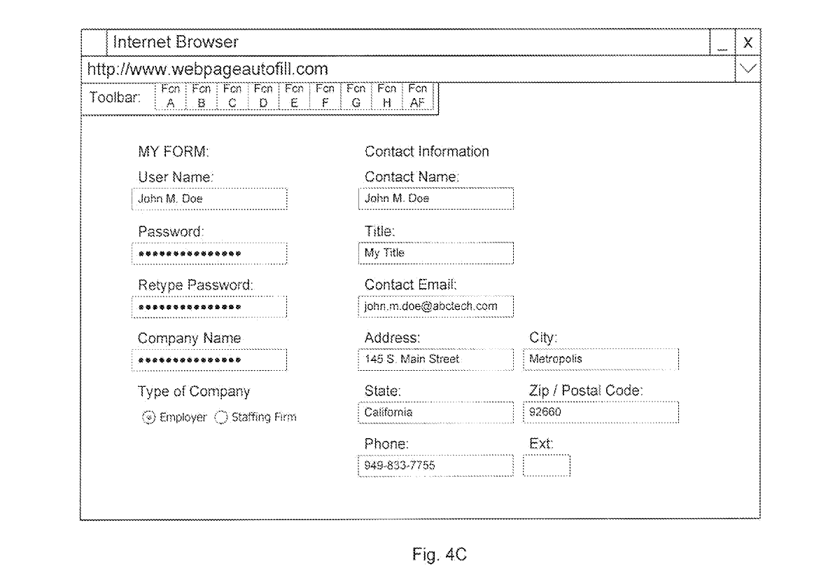

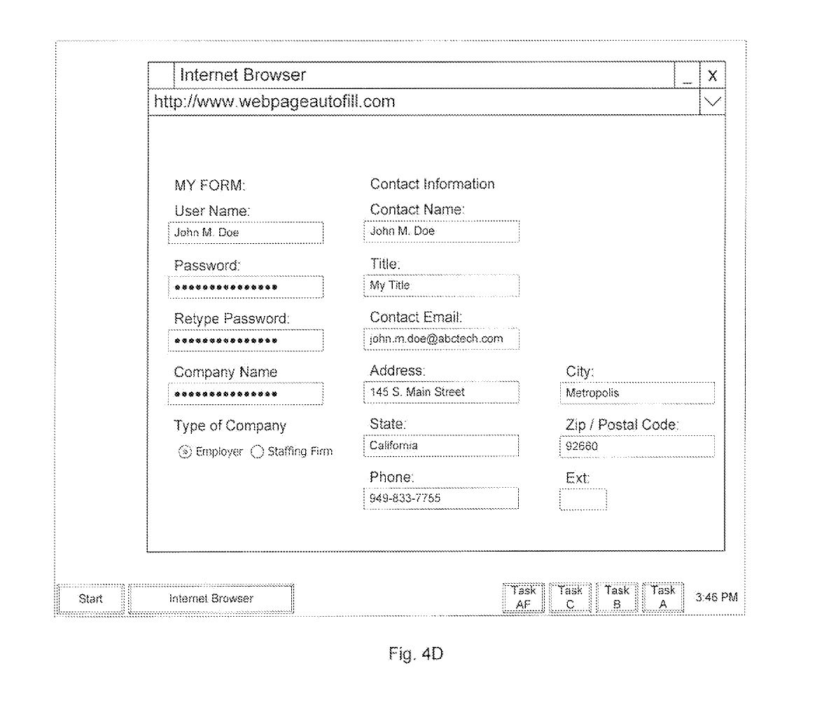

FIG. 4A illustrates a flow diagram of another exemplary method 400 of providing information to a user communication device for the purpose of auto populating one or more website forms with information in accordance with another embodiment of the invention. In this example, the operations of the method 400 are mostly implemented by the resume processing server 204. According to the method 400, the resume processing server 204 receives the resume data from the user communication device 206 via the network 202 (block 402). As discussed above, the resume processing server 204 may receive the user's resume data in a number of different manners. The resume processing server 204 then stores the resume data in a database, such as a local database or a remote database (block 404).

The resume processing server 204 then receives a request to download the auto populate program from the user communication device 206 via the network (block 406). The auto populate program may be adapted to produce a toolbar that sits on top of a browser on a display of the user communication device 206 which performs the auto populate function. Alternatively, the auto populate program may be adapted to produce a widget (also referred to as a widget engine, panel, gadget, or klip) that sits on top of the desktop of the display of the user communication device 206. In response to the request, the resume processing server 204 then sends the auto populate program to the user communication device 202 via the network 202 (block 408). In response to receiving the auto populate program, the user causes the user communication device 206 to run the auto populate program which, as discussed above, may produce a toolbar or widget to appear on a display of the user communication device 206 (block 410). Utilizing the auto populate program, the user using the user communication device 206 enters a username and password (block 412).

The auto populate program then causes the user communication device 206 to send the username and password to the resume processing server 204 via the network 202 (block 414). The resume processing server 204 then authenticates user's eligibility to receive the auto populating service using the received username and password (block 416). If the user is eligible to receive the service, the resume processing server 204 then sends the user's resume data to the user communication device 206 via the network 202 (block 418). The auto populate program captures the resume data for auto populating purposes. The auto populate program may also be able to upload the user resume data to the resume processing server 204.

The auto populate program may store the resume data for auto populating a webpage form at a later date or time, without having to access the resume data again from the resume processing server 204. However, at such later date or time, the auto populate program may request for resume information updates from the resume processing server 204 prior to auto populating a webpage form. This may be automatic or in response to the user. Thus, this allows the resume data stored in the auto populate program to be current or “in sync” with the resume information stored in the database of the resume processing server 204. Alternatively, or in addition to, the resume processing server 204 may automatically update the resume information stored in the auto populate program in response to the user making edits to the resume information stored in the database of the resume processing server 204. Again, this allows the resume data stored in the auto populate program to be current or “in sync” with the resume information stored in the database of the resume processing server 204.

FIG. 4B illustrates a flow diagram of another exemplary method 450 of auto populating a form on a website with information in accordance with another embodiment of the invention. Using the auto populate program running on the user communication device 206, the user is able to populate forms on visited job posts websites with some or all of the user's resume data. In this regard, the user using the user communication device 206 accesses the job posts website which may include one or more webpages containing a form to receive resume data (block 452). The user then activates the auto populate program running on the user communication device 206 (block 454). In response, the auto populate program populates one or more fields of the form with the user's resume data (block 456). Similar to the previous embodiment, if the form is spread over two or more webpages, the user may have to activate the auto populate program for each of the webpages. As in the framed browser embodiment, the auto populate program framed browser may auto-complete sequential pages on behalf of the user, leaving the user at the final completion page. The user may then have to activate a submit button on the appropriate webpage to cause the user communication device 206 to send the resume data to the job posts server 208 or 210 via the network 202. Alternatively, the auto populate program may also be able to automatically submit the resume data to the job posts server. Blocks 454 and 456 may be repeated to complete a form for each of the visited job posts website.

After populating the form on the one or more webpages, the auto populate program may cause the user communication device 206 to send a report regarding the auto popuate operation to the resume processing server 204 via the network 202 (block 458). For example, the report may indicate information related to the website pertaining to the submitted form (e.g., a URL, the name of the job posts entity, etc.), the time and date of the form submission, and any other pertinent information. Additionally, the report may further indicate one or more fields that were not completed, as well as one or more fields including its corresponding content that the user edited prior to submission. In response to receiving the report, the resume processing server 204 updates a history log pertaining to the user with the information contained in the report (block 460). The history log may be stored in the local or remote database. Also, the resume processing server 204 may update the resume information based on the information on the form edited by the user.

FIG. 4C illustrates a screen shot of the exemplary auto populate toolbar program for performing an auto populating function in accordance with another embodiment of the invention. As the screen shot illustrates, the internet browser includes a toolbar which may have several functions, such as Fcn A though H and AF. In this example, the function “Fcn AF” is the auto fill function. In this example, the user has access the webpage indicated by URL “http://www.webpageautofill.com.” When the user initially accesses the webpage, the fields of the form are typically blank or may have some default information therein. Similar to the framed browser, the toolbar may be adapted to provide some visual indicator (e.g., highlight, change color, etc.) to the fields of the webpage form in which it is capable of auto populating with corresponding resume information. This would remind the user of the framed browser's ability to auto populate the emphasized fields of the webpage form. When the user activates the auto fill toolbar function “Fcn AF” button, the toolbar function populates the fields of the form with the embedded data as shown. If the user needs to fill another form on another webpage, the user accesses the webpage by inputting its URL on the framed buffer, and then activate the auto fill function to populate the various fields of the form.

FIG. 4D illustrates a screen shot of the exemplary auto populate widget program for performing an auto populating function in accordance with another embodiment of the invention. As the screen shot illustrates, the desktop includes a taskbar which may have several task buttons, such as Tasks A though C and AF. In this example, the task button “Task AF” is the auto fill widget. In this example, the user has access the webpage indicated by URL “http://www.webpageautofill.com.” As with the framed browser and the toolbar, the widget may be adapted to provide some visual indicator (e.g., highlight, change color, etc.) to the fields of the webpage form in which it is capable of auto populating with corresponding resume information. This would remind the user of the framed browser's ability to auto populate the emphasized fields of the webpage form. When the user initially accesses the webpage, the fields of the form are typically blank or may have some default information therein. When the user activates the auto fill widget, the widget populates the fields of the form with the embedded data as shown. If the user needs to fill another form on another webpage, the user accesses the webpage by inputting its URL on the framed buffer, and then activate the auto fill function to populate the various fields of the form.

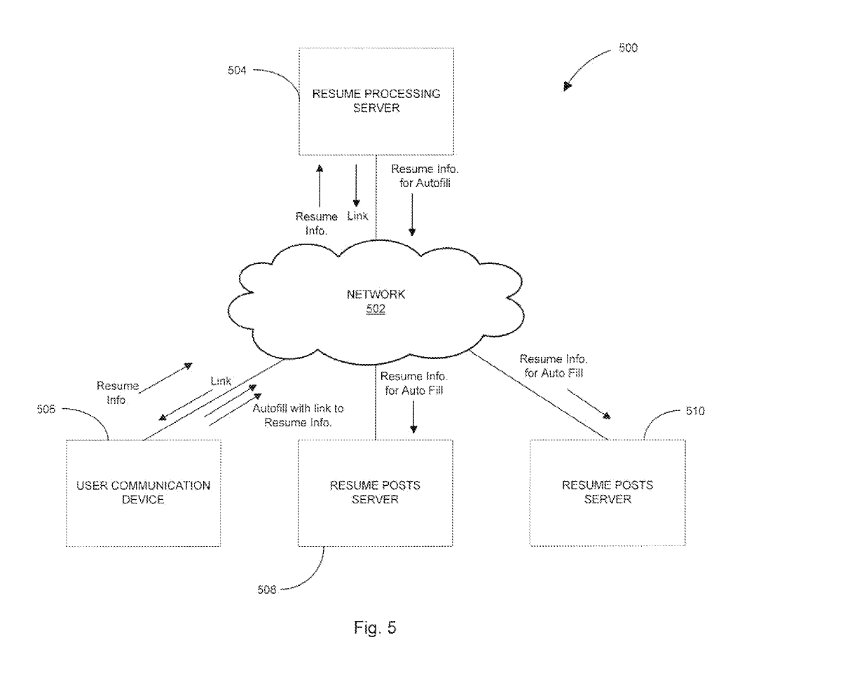

FIG. 5 illustrates a block diagram of another exemplary communications system 500 in accordance with another embodiment of the invention. The communications system 500 is a variant of the communication system 200 previously discussed. Instead of the resume processing server sending the user resume data to the user communication device, the resume processing server sends a link to the user resume data. When the user visits a website with a form and activates the auto populate function, the resume processing server then sends the user resume data directly to the job resume server. In particular, the communications system 500 comprises a network 502, a resume processing server 504 coupled the network 502, a user communication device 506 coupled to the network 202, and one or more resume posts servers, such as servers 508 and 510, coupled to the network 202.

The auto populate method operates as follows. The user using the user communication device 506 sends his/her resume data to the resume processing server 504 via the network 502. The resume processing server 504 stores the user's resume data in a local or remote database. The resume processing server 504 then receives a request from the user communication device 506 to perform an auto populate operation. In response to the request, the resume processing server 506 sends a link to the user's resume data to the user communication device 506 via the network 502. When the user visits a resume posts website containing a form to receive resume data and activates the auto populate framed browser or program, the link and information related to the form (e.g., the URL and source data) are sent to the resume processing server 506. In response, the resume processing server 504 sends the user's resume data directly to the resume posts server to populate the form with the data. The resume processing server 204 may then update the user's history log with information related to the completion of the form.

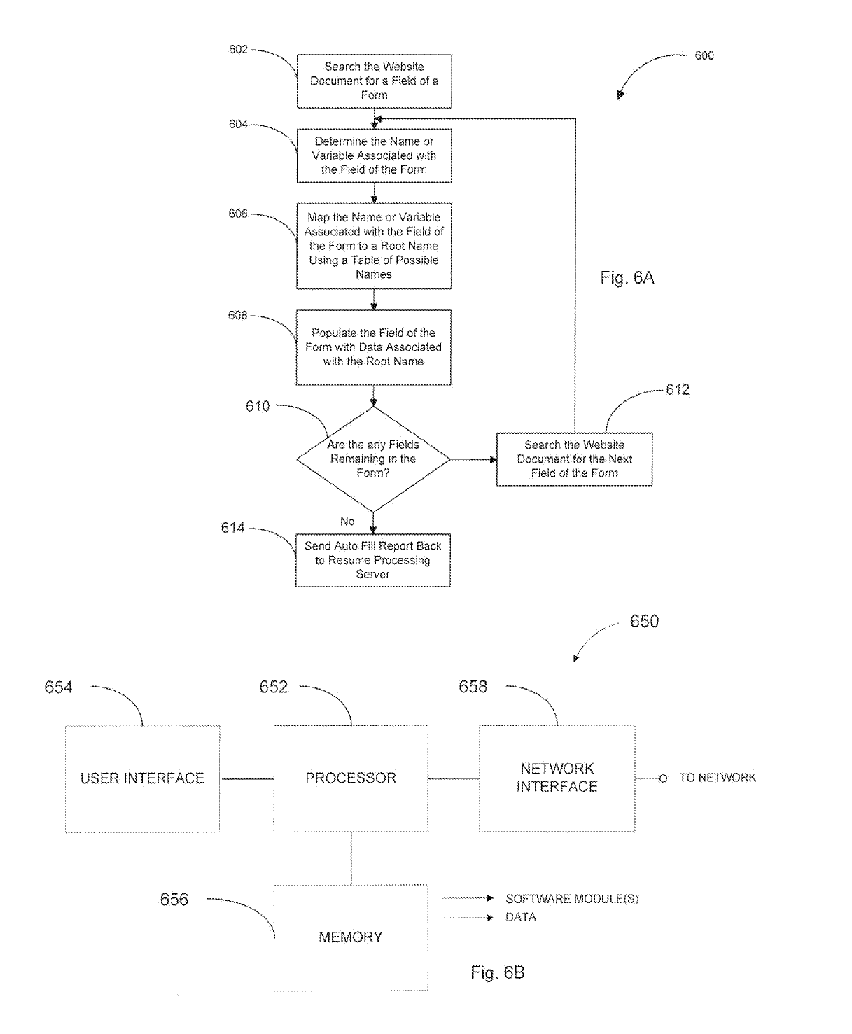

FIG. 6A illustrates a flow diagram of an exemplary method 600 of auto populating a form on a website with information in accordance with another embodiment of the invention. The method 600 may be implemented by the auto populate framed browser or program running on the user communication device as previously discussed. As shown in FIG. 6B, a more detailed example of a user communication device 650 may comprise a processor 652 (e.g., a microprocessor, a reduced instruction set computer (RISC) processor, microcontroller, etc.), a user interface 654 (e.g., a display, keyboard, pointing device (e.g., a mouse, trackball, etc)), a memory 656 for storing data and software module(s) pertaining to the auto populate framed browser or program, and a network interface 658 for sending and receiving information to and from a network. In this example, the method 600 begins after a user has accessed a webpage containing a detected form to receive resume or other type of data.

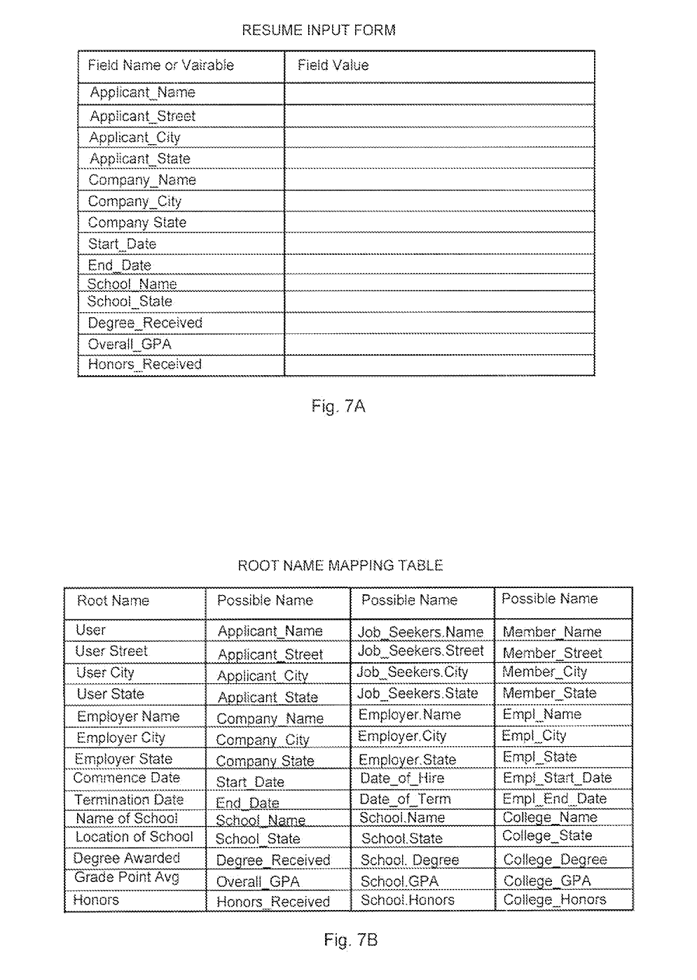

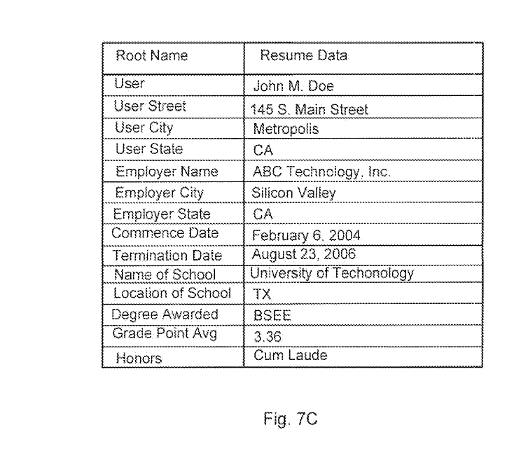

According to the method 600, the processor 652 under the control of the software module(s) searches the webpage for a field of the form (block 602). As an example, FIG. 7A illustrates an exemplary resume input form that may be provided on one or more webpages. In this example, the form may include such fields as applicant's name, applicant's street, applicant's city, and others. If the webpage is an HTML document, the processor 652 may search for particular codes or commands that is associated with a field of a form. The processor 652 then determines the name or variable associated with the field of the form (block 604). For example, if the first field identified pertains to the applicant's name, the name or variable associated with the field may be Applicant_Name as indicated in the webpage source file.

The processor 652 then maps the name or variable associated with the field of the form to a root name using, for example, a table of possible names (block 606). The root name is associated with the corresponding user resume data. FIG. 7B illustrates an exemplary root name mapping table. The first column of the table identifies the root names pertaining to corresponding resume data. For example, the root name “User” corresponds to the user's name, the root name “User Street” corresponds to the street address of the user's residence, and the root name “User City” corresponds to the city of the user's residence. The subsequent columns of the table identify possible names for the corresponding root names. For example, possible names for the “User” include “Applicant_Name”, “Job_Seekers.Name”, and “Member_Name.” Thus, in this example, the processor 652 determines that the root name for the field name or variable “Applicant_Name” is “User.”

According to the method 600, the processor 652 then populates the field with the data associated with the root name (block 608). FIG. 7C illustrates a table which maps the root name to the corresponding data. In this example, the data associated with the root name “User” is “John M. Doe.” Thus, in this example, the processor 652 populates the Applicant_Name field with “John M. Doe.” Then, according to the method 600, the processor 652 determines whether there are any remaining fields in the form that need to be populated (block 610). If there are one or more fields remaining, the processor 652 then searches the webpage for another field of the form (block 612). The processor 652 then repeats the operations specified in blocks 604 through 608 for this field. If, on the other hand, the processor 652 determines that there are no more remaining fields in the form in block 610, the processor 614 may cause the form to be submitted to the job posts server, and may then send a report containing information related to the submitted form to the resume processing server (block 614).

The examples provided herein have to do with the auto populating of a website form adapted to receive user resume data. It shall be understood that the embodiments of the invention may be applicable to auto populating website forms adapted to receive other types of data. For example, the embodiments of the invention may be applicable for auto populating forms to receive job information, credit card information, biographical information, shipping information, financial information, dating profile information, social network information, and others.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of populating and submitting a form on one or more webpages, comprising:
receiving data from a first server via a network;
accessing the form on the one or more webpages via the network;
automatically populating one or more fields of the form with some or all of the data; and
sending the populated form to a second server via the network.

2. The method of claim 1, further comprising:
generating a framed browser; and
embedding the data in the framed browser.

3. The method of claim 2, wherein generating the framed browser comprises receiving a script that causes the generation of the framed browser from the first server via the network.

4. The method of claim 2, wherein automatically populating one or more fields of the form comprises activating the framed browser to automatically populate the one or more fields of the form with some or all of the data.

5. The method of claim 1, further comprising executing an auto populate program, wherein the auto populate program is adapted to automatically populate the one or more fields of the form with some or all of the data

6. The method of claim 5, wherein the auto populate program comprises a tool bar or widget graphically provided on a display.

7. The method of claim 5, further comprising downloading the auto populate program via the network.

8. The method of claim 5, wherein the auto populate program is further adapted to send the data to the first server via the network.

9. The method of claim 1, further comprising sending a request for the data to the first server via the network.

10. The method of claim 9, wherein sending the request for the data comprises activating a link on a webpage provided by the first server via the network.

11. The method of claim 9, wherein sending the request for the data comprises activating an auto populate program to send the request for the data to the first server via the network.

12. The method of claim 1, further comprising sending a report to the first server via the network, wherein the report includes information related to the submission of the populated form to the second server.

13. The method of claim 12, wherein the information related to the submission of the populated form comprises any one or more of the following:
information related to one or more addresses of the one or more webpages containing the form;
information related to one or more fields of the form which could not be auto populated with some or all of the data; and
information related to one or more fields of the form which some or all of the data was edited prior to sending the populated form to the second server.

14. The method of claim 1, wherein automatically populating the one or more fields of the form with some or all of the data, comprises:
searching the one or more webpages for a field of the form;
determining a name or variable corresponding to the field of the form;
determining a root name corresponding to the name or variable;
determining a portion of the data corresponding to the root name; and
populating the field of the form with the portion of the data.

15. The method of claim 1, wherein the data comprises resume information, job information, credit card information, biographical information, shipping information, financial information, dating profile information, or social network information.

16. The method of claim 1, wherein the form is spread over a plurality of webpages, and further wherein automatically populating one or more fields within each of the webpages.

17. The method of claim 1, wherein sending the populated form to the second server comprises sending the populated form to the second server in response to the user activating a submit button or automatically sending the populated form to the second server.

18. The method of claim 1, further comprising receiving updates to the data from the first server via the network.

19. The method of claim 1, further comprising providing a visual indicator proximate the one or more fields of the form indicating that the one or more fields are capable of being auto populated with some or all of the data.

20. A user communication device, comprising:
a network interface; and
a processor adapted to:
receive data from a first server via the network interface;
access one or more webpages including a form via the network interface;
automatically populate one or more fields of the form with some or all of the data; and
sending the populated form to a second server via the network interface.

21. The user communication device of claim 20, wherein the processor is further adapted to:
generate a framed browser;
embed the data in the framed browser; and
automatically populate one or more fields of the form with some or all of the data in response to a user activating the framed browser.

22. The user communication device of claim 20, wherein the processor is further adapted to execute an auto populate program, wherein the auto populate program is adapted to automatically populate the one or more fields of the form with some or all of the data

23. The user communication device of claim 20, wherein the processor is further adapted to send a request for the data to the first server via the network interface.

24. The user communication device of claim 20, wherein the processor is further adapted to send a report to the first server via the network interface, wherein the report includes information related to the sending of the populated form to the second server.

25. The user communication device of claim 20, wherein the processor is adapted to automatically populate the one or more fields of the form with some or all of the data by:
searching the one or more webpages for a field of the form;
determining a name or variable corresponding to the field of the form;
determining a root name corresponding to the name or variable;
determining a portion of the data corresponding to the root name; and
populating the field of the form with the portion of the data.

26. A method of populating and submitting a form on one or more webpages, comprising:
receiving a link to data from a first server via a network;
accessing the form on the one or more webpages via the network;
sending a command to the first server via the network, to automatically populate one or more fields of the form with some or all of the data, and send the populated form to a second server.

27. The method of claim 26, wherein the command comprises the link to the data and address information of the second server.

28. A method of facilitating the populating of a form on one or more webpages with data, comprising:
receiving a request for data for automatically populating the form from a user communication device via a network;
accessing the data from a database; and
sending data to the user communication device via the network.

29. The method of claim 28, further comprising sending a script for generating a framed browser with the data embedded therein to the user communication device via the network.

30. The method of claim 29, wherein the script further causes the automatic populating one or more fields of the form with some or all of the data.

31. The method of claim 28, further comprising sending an auto populate program to the user communication device via the network, wherein the auto populate program is adapted to automatically populate the one or more fields of the form with some or all of the data

32. The method of claim 31 wherein the auto populate program comprises a tool bar graphically provided on a display of the user communication device.

33. The method of claim 28, further comprising receiving a report from the user communication device via the network, wherein the report includes information related to a submission of the populated form.

34. The method of claim 28, further comprising updating a history log stored in the database with some or all of the information related to the submission of the populated form.

35. A method of facilitating the populating of a form on one or more webpages with data, comprising:
receiving a request for data for automatically populating the form from a user communication device via a network;
sending a link to the data to the user communication device via the network;
receiving a request to automatically populate the form data from the user communication device via the network, wherein the request includes the link to the data and information related to an identify of the form;
accessing the data from a database using the link;
accessing the form using the information related to the identity of the form;
populating one or more fields of the form with some or all of the data; and
sending the populated form to a server via the network.
